(19) United States
(12) Patent Application Publication
(10) Pub. No.: US 2026/0298620 A1
(43) Pub. Date: Oct. 1, 2026

(54) MEASURING APPARATUS AND METHOD FOR CONTROLLING MEASURING APPARATUS

(71) Applicant: Lasertec Corporation, Yokohama (JP)

(72) Inventors: Yoshihiro NISHIMURA, Yokohama (JP); Shoichi SHIMODA, Yokohama (JP)

(21) Appl. No.: 19/578,062

(22) Filed: Mar. 25, 2026

(30) Foreign Application Priority Data
Mar. 26, 2025 (JP) 2025-051533

(51) Int. Cl. G01B 11/06; G01B 11/24

(52) U.S. Cl. CPC G01B 11/0608; G01B 11/2441

(57) ABSTRACT

A measuring apparatus includes: a phase shifting mechanism configured to generate a plurality of optical path differences between a first optical path and a second optical path; and a standard tilt acquisition unit configured to acquire a standard tilt of the sample, wherein: the photodetector is configured to detect the interference light at the plurality of optical path differences; and the standard tilt acquisition unit is configured to: acquire height information at a plurality of measurement points on the sample based on a result of the detection of the interference light at the plurality of optical path differences; acquire tilt information between measurement points based on the height information at the plurality of measurement points; and acquire the standard tilt based on statistical processing performed for a plurality of pieces of tilt information.

### INCORPORATION BY REFERENCE

This application is based upon and claims the benefit of priority from Japanese Patent Application No. 2025-051533, filed on Mar. 26, 2025, the disclosure of which is incorporated herein in its entirety by reference for all purposes.

### BACKGROUND

The present disclosure relates to a measuring apparatus and a method for controlling a measuring apparatus.

There have been techniques for measuring the surface shape of a sample as in the past.
[Patent Literature 1] Japanese Unexamined Patent Application Publication No. 2009-20448

### SUMMARY

It should be noted that in order to measure the surface shape of a sample, it is important to obtain the standard tilt of the sample and correct its position so that the sample is not tilted. An object of the present disclosure is to provide a measuring apparatus and the like for accurately measuring the standard tilt of a sample by a simple method.

A measuring apparatus according to the present disclosure includes:
an optical system including a photodetector, a separation part configured to separate illumination light emitted from a light source, and a reference surface, and configured to guide interference light caused by reflected light of sample illumination light reflected on a sample and reference light of reference illumination light reflected on the reference surface to the photodetector, the sample illumination light being light originally traveling through the separation part toward the sample, and the reference illumination light being light originally traveling through the separation part toward the reference surface;
a phase shifting mechanism configured to generate a plurality of optical path differences between a first optical path and a second optical path, the first optical path including at least one of an optical path of the sample illumination light and an optical path of the reflected light, and the second optical path including at least one of an optical path of the reference illumination light and an optical path of the reference light; and
a standard tilt acquisition unit configured to acquire a standard tilt of the sample, in which
the photodetector is configured to detect the interference light at the plurality of optical path differences, and
the standard tilt acquisition unit is configured to:
acquire height information at a plurality of measurement points on the sample based on a result of the detection of the interference light at the plurality of optical path differences;
acquire tilt information between measurement points based on the height information at the plurality of measurement points; and
acquire the standard tilt based on statistical processing performed for a plurality of pieces of tilt information.

In the measuring apparatus according to the present disclosure, the standard tilt acquisition unit may acquire the standard tilt based on, among the plurality of pieces of tilt information, a tilt of which a frequency of appearance is larger than a predetermined value.

In the measuring apparatus according to the present disclosure, the standard tilt acquisition unit may include tilt information at measurement points belonging to interference fringes of orders different from each other in the statistical processing.

In the measuring apparatus according to the present disclosure, the standard tilt acquisition unit may perform a first masking process for restricting inclusion of tilt information at a measurement point at which an amplitude of an interference signal is smaller than a predetermined value in the statistical processing, the amplitude of the interference signal being based on a change of the optical path difference by the phase shifting mechanism.

In the measuring apparatus according to the present disclosure, the standard tilt acquisition unit may perform a second masking process for restricting inclusion of tilt information at a measurement point at which an amount of change in height information is larger than a predetermined value in the statistical processing.

The measuring apparatus according to the present disclosure may further include:
a determination unit configured to determine whether or not the standard tilt is within a predetermined range; and
a tilt correction unit configured to correct a tilt of the sample based on the standard tilt, in which
the measuring apparatus may repeat acquiring the tilt information and correcting the tilt of the sample based on the tilt information until the standard tilt falls in the predetermined range.

The measuring apparatus according to the present disclosure may further include a determination unit configured to determine whether or not the standard tilt is within a predetermined range, in which the measuring apparatus may acquire, after positively determining that the standard tilt is within the predetermined range, a surface profile of the sample.

The measuring apparatus according to the present disclosure may further include a sample characteristic information acquisition unit configured to acquire characteristic information of the sample, in which the standard tilt acquisition unit may acquire the standard tilt of the sample based on statistical processing determined based on the characteristic information of the sample.

A method for controlling a measuring apparatus according to the present disclosure is a method for controlling a measuring apparatus,
the measuring apparatus including:
an optical system including a photo-detection unit, a separation part configured to separate illumination light emitted from a light source, and a reference surface, and configured to guide interference light caused by reflected light of sample illumination light reflected on a sample and reference light of reference illumination light reflected on the reference surface to the photo-detection unit, the sample illumination light being light originally traveling through the separation part toward the sample, and the reference illumination light being light originally traveling through the separation part toward the reference surface; and
a phase shifting mechanism configured to generate a plurality of optical path differences between a first optical path and a second optical path, the first optical path including at least one of an optical path of the sample illumination light and an optical path of the reflected light, and the second optical path including at least one of an optical path of the reference illumination light and an optical path of the reference light,
   the method including:
generating, by controlling the phase shifting mechanism, the plurality of optical path differences between the first and second optical paths; making the photo-detection unit detect the interference light at the plurality of optical path differences; and
acquiring a standard tilt of the sample based on a result of the detection by the photo-detection unit, in which
the acquiring of the standard tilt of the sample includes:
acquiring height information at a plurality of measurement points on the sample based on a result of the detection of the interference light at the plurality of optical path differences;
acquiring tilt information between measurement points based on the height information at the plurality of measurement points; and
acquiring the standard tilt based on statistical processing performed for a plurality of pieces of tilt information.

In the method for controlling a measuring apparatus according to the present disclosure, in the acquiring of the standard tilt, the standard tilt may be acquired based on, among the plurality of pieces of tilt information, a tilt of which a frequency of appearance is larger than a predetermined value.

In the method for controlling a measuring apparatus according to the present disclosure, in the acquiring of the standard tilt, tilt information at measurement points belonging to interference fringes of orders different from each other in the statistical processing may be included in the statistical processing.

In the method for controlling a measuring apparatus according to the present disclosure, in the acquiring of the standard tilt, a first masking process for restricting inclusion of tilt information at a measurement point at which an amplitude of an interference signal is smaller than a predetermined value in the statistical processing may be performed, the amplitude of the interference signal being based on a change of the optical path difference by the phase shifting mechanism.

In the method for controlling a measuring apparatus according to the present disclosure, in the acquiring of the standard tilt, a second masking process for restricting inclusion of tilt information at a measurement point at which an amount of change in the height information is larger than a predetermined value in the statistical processing may be performed.

The method for controlling a measuring apparatus according to the present disclosure further include:
determining whether or not the standard tilt is within a predetermined range; and;
correcting a tilt of the sample based on the standard tilt, in which
the acquiring of the standard tilt and the correcting of the tilt of the sample based on the standard tilt may be repeated until the standard tilt falls in the predetermined range.

The method for controlling a measuring apparatus according to the present disclosure may further include:
determining whether or not the standard tilt is within a predetermined range; and;
acquiring, after positively determining that the standard tilt is within the predetermined range, a surface profile of the sample.

The method for controlling a measuring apparatus according to the present disclosure may further include acquiring characteristic information of the sample, in which in the acquiring of the standard tilt, the standard tilt of the sample may be acquired based on statistical processing determined based on the characteristic information of the sample.

According to the present disclosure, it is possible to provide a measuring apparatus and the like capable of easily and accurately measuring the standard tilt of a sample.

The above and other objects, features and advantages of the present disclosure will become more fully understood from the detailed description given hereinbelow and the accompanying drawings.

### BRIEF DESCRIPTION OF DRAWINGS

FIG. 1 shows an example of an overall configuration of a measuring apparatus 100 according to an embodiment;

FIG. 2 shows an example of a configuration of the optical system 200 of the measuring apparatus 100 according to the embodiment;

FIG. 3 shows an example of a configuration of an interference-type objective lens 13 of the measuring apparatus 100 (optical system 200) according to the embodiment;

FIG. 4 is a perspective view of a Michelson-type interference unit;

FIG. 5A shows a sample having a standard tilt φ placed on a stage according to an embodiment;

FIG. 5B shows the sample of which the standard tilt is cancelled out by tilting the stage according to the embodiment;

FIG. 6 is a block diagram showing a configuration of functions disclosed herein of the measuring apparatus 100;

FIG. 7 shows an image obtained by expressing height information calculated from a luminance value of each pixel acquired by a height information acquisition unit 607 in gradation on a plane perpendicular to the main optical axis of the interference-type objective lens 13 (i.e., a height image of a sample 101);

FIG. 8 shows height information on a line α-α shown in FIG. 7 (the line is parallel to the X axis for the sake of explanation);

FIG. 9 shows a part of the X-coordinate range (X=500 μm to 725 μm) shown in FIG. 8 shown on a different scale;

FIG. 10 is a histogram showing the frequences of appearances of a plurality of pieces of tilt information acquired by a tilt information acquisition unit 608 for each section of tilt information;

FIG. 11 is a schematically-shown histogram showing the frequences of appearances of a plurality of pieces of tilt information for each section of tilt information after a first masking process is performed;

FIG. 12 is a schematic diagram of a cross section of a sample 101 formed of a pattern-less flat surface;

FIG. 13 shows a histogram obtained by measuring the sample 101 formed of a pattern-less flat surface;

FIG. 14 is a schematic diagram of a cross section of a sample 101 formed of a patterned flat surface;

FIG. 15 shows a histogram obtained by measuring the sample 101 formed of a patterned flat surface;

FIG. 16 is a schematic diagram of a cross section of a sample 101 formed of a curved surface;

FIG. 17 shows a histogram obtained by measuring the sample 101 formed of a curved surface; and

FIG. 18 is a flowchart of a method for controlling a measuring apparatus according to an embodiment.

### DESCRIPTION OF EMBODIMENTS

### Embodiments

Embodiments according to the present disclosure will be described hereinafter with reference to the drawings. Firstly, an overall configuration of a measuring apparatus 100 will be described, and then a function of measuring a standard tilt φ of a sample 101 in the measuring apparatus 100 will be described. Note that the disclosure which is specified in the claims is not limited to the embodiments shown below. Further, not all of the components/structures described in the embodiments are indispensable as means for solving the problem. In order to clarify the explanation, the following description and the drawings are partly omitted and simplified as appropriate. The same elements are denoted by the same reference numerals (or symbols) throughout the drawings, and redundant descriptions are omitted as appropriate.

### 1. Overall Configuration of Measuring Apparatus According to Embodiment

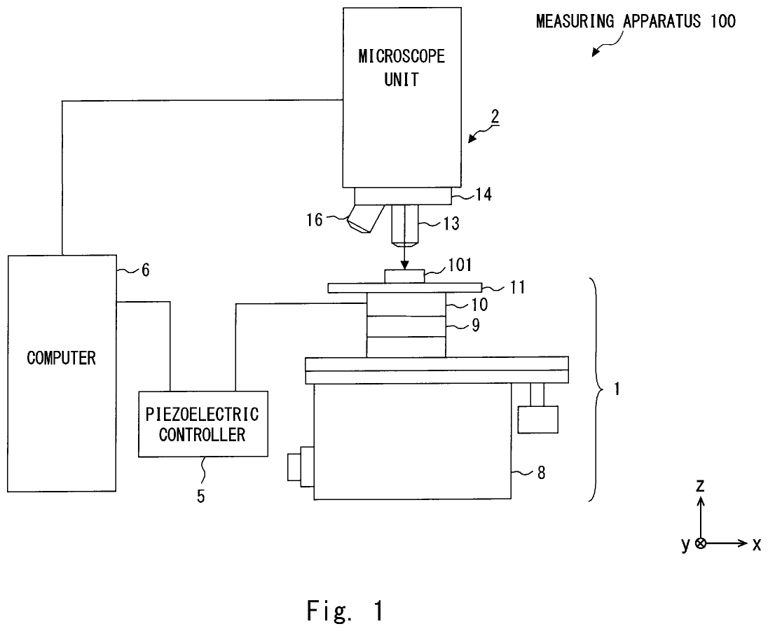

FIG. 1 shows an example of an overall configuration of a measuring apparatus 100 according to an embodiment. The measuring apparatus 100 includes a microscope stage 1, a microscope unit 2, a piezoelectric controller 5, and a computer 6. In some embodiments, the measuring apparatus 100 may include components/structures other than the components described above.

A sample 101 is placed on the microscope stage 1. The microscope unit 2 is installed above the microscope stage 1 so as to be opposed to the sample 101. The microscope unit 2 emits scanning light (illumination light) to the sample 101 placed on the microscope stage 1. Then, reflected light reflected on the sample 101 is combined with reference light by an interference-type objective lens 13 of the microscope unit 2. The interference light synthesized by the interference-type objective lens 13 is detected by a photodetector of the microscope unit 2. Note that the relative positions of the microscope stage 1 and the microscope unit 2 in the height direction can be finely changed by a piezoelectric Z-positioner 10 provided on the microscope stage 1. As will be described later, the piezoelectric Z-positioner 10 is a phase shifting mechanism for generating a plurality of optical path differences between a first optical path, which includes at least one of the optical path of the sample illumination light and the optical path of the reflected light, and a second optical path, which includes at least one of the optical path of the reference illumination light and the optical path of the reference light. The movement of the piezoelectric Z-positioner 10 in the height direction is controlled by the computer 6 through the piezoelectric controller 5.

The interference light detected by the photodetector is output to the computer 6 as data thereof. The computer 6 performs arithmetic processing on the data of the interference light input from the microscope unit 2. In this way, the computer 6 can obtain the standard tilt φ of the sample 101 as will be described later in detail.

The microscope stage 1 is installed on a vibration isolation table or the like (not shown). The microscope stage 1 includes, from the bottom, an XYZ stage 8, a gonio-stage 9, a piezoelectric Z-positioner 10, and a sample holder 11. The XYZ stage 8 can move the sample holder 11 in three-axis (X, Y, Z) directions relative to the interference-type objective lens 13. Note that the Z direction is a direction parallel to the optical axis. Further, the XY directions are directions perpendicular to the optical axis, and the X and Y directions are perpendicular to each other. The gonio-stage 9 is installed on the XYZ stage 8. The gonio-stage 9 is a mechanism for adjusting the tilt angle of the piezoelectric Z-positioner 10 and the sample holder 11 installed above the gonio-stage 9. The density (i.e., crowdedness/sparseness) of interference fringes in the interference image can be changed by changing the tilt angle.

Meanwhile, the piezoelectric Z-positioner 10 is a mechanism for finely adjusting the movement of the height direction (Z direction) of the sample holder 11 installed above the piezoelectric Z-positioner 10. That is, the microscope stage 1 includes the XYZ stage 8 and the piezoelectric Z-positioner 10 as means for adjusting the movement in the Z direction. The rough movement in the Z direction is carried out by the XYZ stage 8, and the fine movement in the Z direction is carried out by the piezoelectric Z-positioner 10. The piezoelectric Z-positioner 10 is driven by a piezoelectric element, and can move the sample holder 11 in the height direction in the unit of 0.1 nm. Therefore, the positional resolution of the piezoelectric Z-positioner 10 in the Z direction is higher than that of the XYZ stage. That is, the piezoelectric Z-positioner 10 accurately moves the sample or the like at a pitch finer than that of the XYZ stage 8. The piezoelectric Z-positioner 10 is controlled by the computer 6 through the piezoelectric controller 5. The sample 101, which is the object to be measured, is placed on the sample holder 11.

The microscope unit 2 includes the interference-type objective lens 13. Further, in some embodiments, the microscope unit 2 may include a revolver 14 on its surface opposed to the sample 101. The interference-type objective lens 13 and an ordinary objective lens 16 are attached to the revolver 14, and they constitute a part of the microscope unit 2. By rotating the revolver 14, the objective lens used for the scanning on the sample 101 can be arbitrarily selected from the interference-type objective lens 13 and the ordinary objective lens 16. Therefore, in some embodiments, it is possible to arbitrarily switch the measuring mode of the measuring apparatus 100 between an interferometer mode and a confocal mode. While the interference-type objective lens 13 is selected in the interferometer mode, the ordinary objective lens 16 is selected in the confocal mode. However, other types of objective lenses may be fixed to the revolver 14, and the measuring mode of the measuring apparatus 100 may arbitrarily selected from a plurality of modes including modes other than the above-described modes. Note that the interferometer mode and the confocal mode are just names related the selection of the objective lens. That is, an interference system may be formed by using the confocal mode, and a confocal image may be acquired by using the interferometer mode.

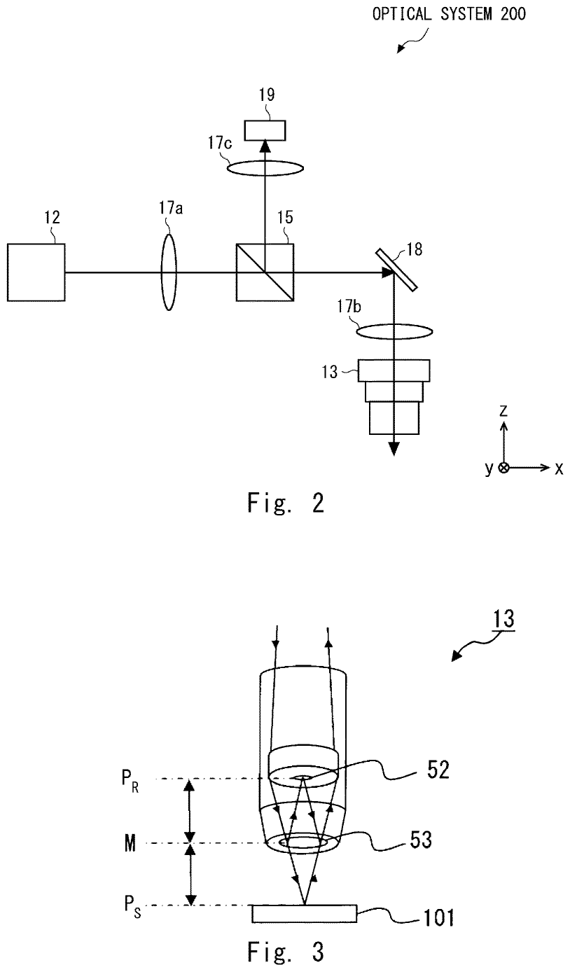

FIG. 2 shows an example of a configuration of an optical system 200 of the measuring apparatus 100 according to the embodiment. This optical system 200 is provided inside the microscope unit 2 shown in FIG. 1. That is, the microscope unit 2 includes the optical system 200. As shown in FIG. 2, the optical system 200 includes a light source 12, lenses 17a, 17b, and 17c, a beam splitter 15, a vibrating mirror 18, an interference-type objective lens 13, and a photodetector 19.

The light source 12 generates illumination light for illuminating the sample 101. In some embodiments, the optical system 200 may include a slit (not shown). Further, the optical path of the illumination light may be changed, for example, by forming an alternative path so that the illumination light passes through the slit (not shown) between the light source 12 and the beam splitter 15. Further, in some embodiments, the optical system 200 may include the above-described revolver 14, and the interference-type objective lens 13 may be switched to the ordinary objective lens 16 through the revolver 14. In this way, in some embodiments, the measuring mode of the measuring apparatus 100 may be switched between the interferometer mode and the confocal mode. Note that in the confocal mode, the lenses 17a, 17b, and 17c, the slit, the beam splitter 15, the vibrating mirror 18, the objective lens 16, and the photodetector 19 constitute a confocal optical system.

As the light source 12, for example, a xenon lamp having a wide continuous spectrum from ultraviolet to infrared (185 nm to 2,000 nm) is used. Note that a white light source including a plurality of emission lines in a continuous spectrum, such as a mercury xenon lamp, may be used. Needless to say, the light source 12 is not limited to xenon lamps. That is, a white diode, a white laser, or the like may be used as the light source 12. Any type of light source 12 may be used as long as the wavelength can be selected by a known method.

Next, optical paths in the optical system 200 will be described. Although an example of optical paths in the interferometer mode will be described hereinafter, the explanation below can be applied as appropriate to the confocal mode.

Illumination light emitted from the light source 12 passes through the lens 17a and enters the beam splitter 15. Note that in the confocal mode, the illumination light passes through the slit upstream from the beam splitter 15. The beam splitter 15 splits (i.e., divides) the light that has entered the beam splitter 15 in such a manner that the amount of reflected light and that of transmitted light (i.e., light that has passed the beam splitter 15) are expressed as roughly 1:1. Therefore, roughly a half of the illumination light passes through the beam splitter 15.

After that, the light traveling in the X axis direction in FIG. 2 is incident on the vibrating mirror 18. The illumination light is scanned on the sample 101 by the vibrating mirror 18. For example, a galvano-mirror, a polygon mirror, or the like can be used as the vibrating mirror 18.

The illumination light reflected in the −Z axis direction by the vibrating mirror 18 is concentrated by the interference-type objective lens 13 and applied to the sample 101. As will be described later, as the reflected light coming from the sample 101 passes through the interference-type objective lens 13, it becomes interference light. Then, this interference light is incident on the vibrating mirror 18, is reflected thereon, and enters the beam splitter 15. After that, roughly a half of the light that has entered the beam splitter 15 is reflected by the beam splitter 15 and is incident on the lens 17c. The lens 17c forms an image of the composite light on the light receiving surface of the photodetector 19. The light that has passed through the lens 17c is received by the photodetector 19. As described above, the optical system 200 guides the illumination light emitted from the light source 12 to the sample 101, and guides the reflected light (interference light) coming from the sample 101 to the photodetector 19.

In this embodiment, the photodetector 19 is, for example, a CCD line sensor. Note that the photodetector 19 may be a CCD camera for taking a confocal image, but it is not limited to this example. As described above, the photodetector 19 detects the interference light caused by the reflected light of the sample illumination light reflected on the sample 101, and acquires interference signals at a plurality of measurement points on the sample 101.

### (Principle of Interference of Reflected Light)

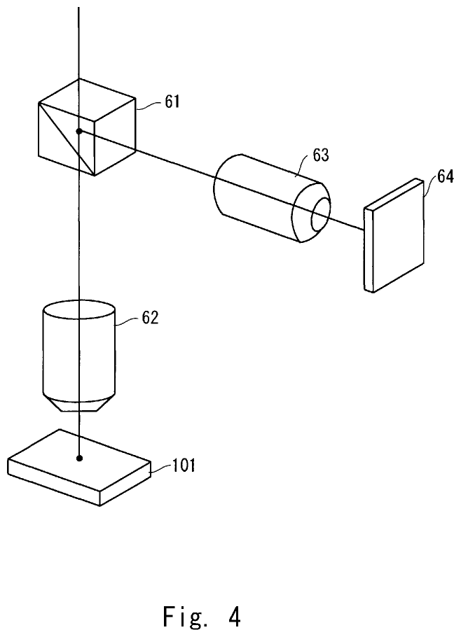

The interference of the reflected light coming from the sample 101 by the interference-type objective lens 13, which is an example of the interference system, will be described. FIG. 3 shows an example of a configuration of the interference-type objective lens 13 of the measuring apparatus 100 (optical system 200) according to the embodiment. This interference-type objective lens 13 is a Mirau interference objective lens. Therefore, an interference optical system is incorporated in the interference-type objective lens 13. Specifically, the cylindrical interference-type objective lens 13 includes a reference mirror 52 (reference surface) and a semi-transparent mirror 53 (separation part). A part of the light that has entered the interference-type objective lens 13 is reflected on the semi-transparent mirror 53 and applied to the reference mirror 52. Then, the light is reflected on the reference mirror 52 and incident on the semi-transparent mirror 53 again. Then, the light is reflected on the semi-transparent mirror 53 and exits from the interference-type objective lens 13 toward the beam splitter 15. The light separated by the separation part and traveling toward the reference surface (reference mirror 52 or the like) is referred to as reference illumination light. The light that returns from the reference surface (reference mirror 52 or the like) to the separation part (semi-transparent mirror 53 or the like) again by the reflection of the reference illumination light by the reference surface (reference mirror 52 or the like) is referred to as reference light. Further, an optical path including at least one of the optical path of the reference illumination light and the optical path of the reference light is referred to as a second optical path.

Meanwhile, the light that has passed through the semi-transparent mirror 53 becomes scanning light (sample illumination light) with which the surface of the sample 101 is irradiated. Reflected light that changes according to the surface shape of the sample 101, which has been irradiated with the sample illumination light, is reflected on the sample 101. The reflected light reflected on the sample 101 passes through the semi-transparent mirror 53 again. The light separated by the separation part and traveling toward the sample 101 is referred to as sample illumination light. The light that returns from the sample 101 to the separation part (semi-transparent mirror 53 or the like) again by the reflection of the sample illumination light by the sample 101 is referred to as reflected light. Further, the optical path including at least one of the optical path of the sample illumination light and the optical path of the reflected light is referred to as a first optical path.

With the above-described configuration, the reflected light and the reference light are combined and become interference light, and this interference light exits from the interference-type objective lens 13. In this embodiment, the relative positions of the sample 101 and the semi-transparent mirror 53 are finely adjusted by the piezoelectric Z-positioner 10 provided on the microscope stage 1. In this way, the optical distance between the sample 101 and the semi-transparent mirror 53 changes. That is, the optical path difference between the first and second optical paths is changed by the driving of the piezoelectric Z-positioner 10 provided on the microscope stage 1. Note that the optical distance between the semi-transparent mirror 53 and the reference mirror 52 is fixed.

As shown in FIG. 2, the interference light generated by the interference-type objective lens 13 configured as described above is reflected on the beam splitter 15 and detected by the photodetector 19 as described above. In this way, the measuring apparatus 100 can acquire interference signals at a plurality of measurement points on the sample 101 by using the photodetector 19.

### (Variations of Interference-type Objective Lens and Interference System)

Note that although a Mirau interference objective lens is used as the interference-type objective lens 13 in this embodiment, a Michelson-type interference unit may be used as the interference-type objective lens in placed of the Mirau interference-type objective lens. FIG. 4 is a perspective view showing a Michelson-type interference unit. This Michelson-type interference unit includes a beam splitter 61, a reflected-light objective lens 62, a reference-light objective lens 63, and a reference mirror 64.

The beam splitter 61 splits (i.e., divides) light into two light beams. One of the light beams (sample illumination light) split by the beam splitter 61 (separation part) is concentrated by the reflected-light objective lens 62 and applied to the sample. Further, the reflected light coming from the sample 101 is incident on the reflected-light objective lens 62 again. Meanwhile, the other light beam (reference illumination light) split by the beam splitter 61 is concentrated by the reference-light objective lens 63 and applied to the reference mirror 64 through the reference-light objective lens 63. The reference mirror 64 reflects the light incident thereon through the reference-light objective lens toward the reflected-light objective lens 62. This light reflected on the reference mirror 64 becomes the reference light. This reference light returns to the beam splitter 61 through the reference-light objective lens 63. The beam splitter 61 combines the reflected light that has entered therein through the reflected-light objective lens 62 and the reference light that has entered through the reference-light objective lens 63, and the resultant light is detected by the photodetector 19 as interference light.

It is possible to, by changing the position of the reference mirror 64 in the optical axis direction or the position of the sample 101 in the height direction, change the optical path difference between the first and second optical paths. As described above, even when a Michelson-type interference unit is used as the interference-type objective lens, the measuring apparatus 100 can acquire, by using the photodetector 19, the interference signal at the measurement position at which the sample 101 is illuminated. Further, the measuring apparatus 100 may make the photodetector 19 acquire the interference light by using other types of interference optical systems including a Linnik-type interference optical system.

Further, in the above-described example, the relative positions of the sample 101 and the semi-transparent mirror 53 are finely adjusted by the piezoelectric Z-positioner 10 provided on the microscope stage 1, and the position of the reference mirror 64 in the optical axis direction or the position of the sample 101 in the height direction is changed. However, the configuration of the present disclosure is not limited to this example. The above-described configuration and the like may be replaced by other types of configurations as long as the optical path difference between the first and second optical paths can be changed. For example, an interference system may be formed, for example, by inserting and removing a plurality of phase plates having different thicknesses in at least one of the first and second optical paths by driving an actuator(s). Examples in which the interference system is replaced by any of various types of interference systems are also within the scope of the technical concept of the present disclosure.

### 2. Function of Measuring Standard Tilt in Measuring Apparatus

Next, a function of measuring the standard tilt φ of a sample 101 in the measuring apparatus 100 according to this embodiment (hereinafter, also referred to as the “function disclosed herein”) will be described.

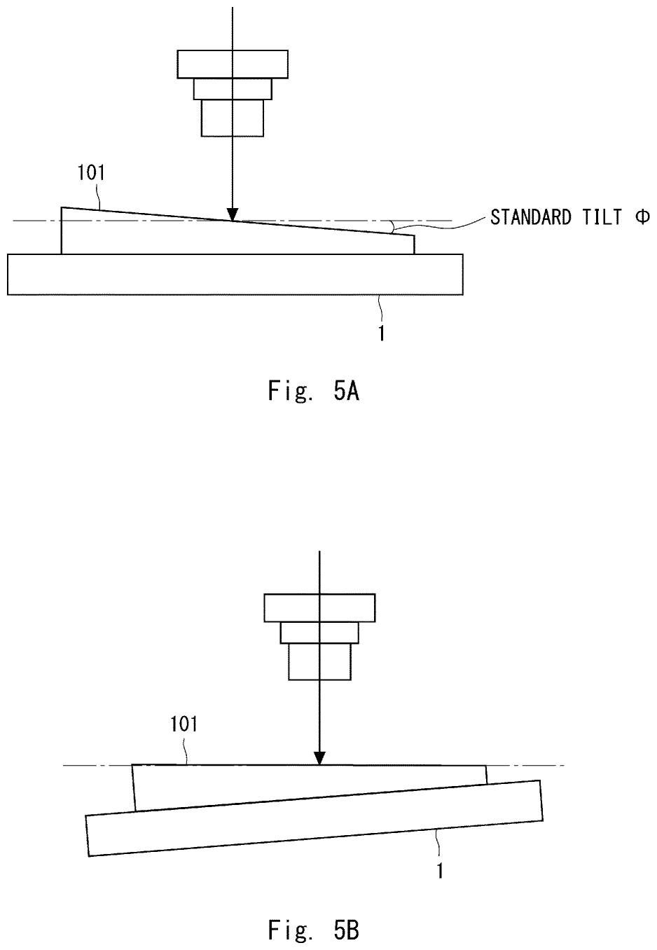

Note that the standard tilt φ of the sample 101 means the tilt angle φ of the sample 101 when the main surface of the sample 101 is tilted with respect to a plane perpendicular to the primary optical axis of the objective lens (13 or 16). As shown in FIG. 5A, even when the sample 101 placed on the stage is placed on the microscope stage 1 which is adjusted in the horizontal direction in advance, the main surface of the sample 101 may be tilted with respect to a plane perpendicular to the primary optical axis of the objective lens (13 or 16) (which may be a horizontal plane) due to the structure of the sample 101 or due to restrictions or the like on the manufacturing process. In order to carry out appropriate measurement for the sample 101 (e.g., measurement of the microscopic shape on the surface), it is desired that the standard tilt φ be 0° or close thereto as shown in FIG. 5B. Therefore, the measuring apparatus 100 according to this embodiment measures the angle φ of the standard tilt of the sample 101 with the configuration described below. Further, in some embodiments, the measuring apparatus 100 changes the posture of the microscope stage 1 based on the measured standard tilt φ so as to cancel out the standard tilt φ (i.e., so as to bring the posture into the state shown in FIG. 5B).

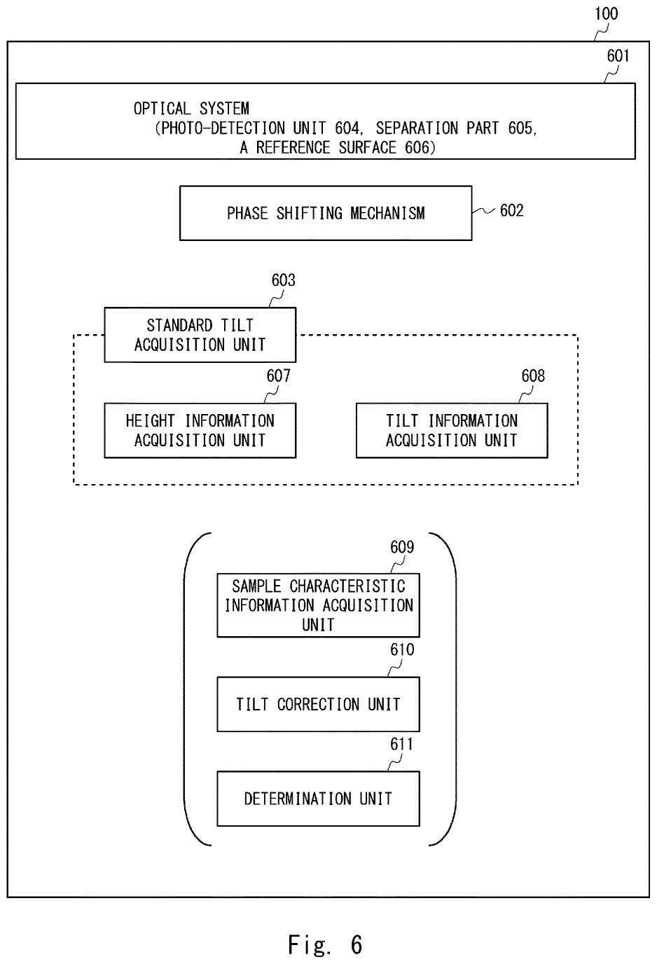

FIG. 6 is a block diagram showing a configuration of the measuring apparatus 100 related to the function disclosed herein. As shown in FIG. 6, the measuring apparatus 100 includes an optical system 601, a phase shifting mechanism 602, and a standard tilt acquisition unit 603. The optical system 601 includes a photo-detection unit 604, a separation part 605, and a reference surface 606. The standard tilt acquisition unit 603 includes a height information acquisition unit 607 and a tilt information acquisition unit 608. Further, in some embodiments, the measuring apparatus 100 may further include at least one of a sample characteristic information acquisition unit 609, a tilt correction unit 610, and a determination unit 611.

The optical system 601 includes a photo-detection unit 604 (photodetector 19), a separation part 605 (semi-transparent mirror 53 or the like) for separating illumination light emitted from the light source, and a reference surface 606 (reference mirror 52 or the like), and guides interference light caused by reflected light of sample illumination light reflected on the sample 101, which is light originally traveling through the separation part 605 toward the sample 101, and reference light of reference illumination light reflected on the reference surface 606, which is light originally traveling through the separation part 605 toward the reference surface 606, to the photo-detection unit 604 (photodetector 19 or the like). For example, the optical system 601 may include the above-described interference-type objective lens 13, and the separation part 605 and the reference surface 606 may be formed by the interference-type objective lens 13.

The phase shifting mechanism 602 generates a plurality of optical path differences between a first optical path, which includes at least one of the optical path of the sample illumination light and the optical path of the reflected light, and a second optical path, which includes at least one of the optical path of the reference illumination light and the optical path of the reference light. The phase shifting mechanism 602 may be formed, for example, by the above-described piezoelectric Z-positioner 10.

The phase shifting mechanism 602 is not limited to the piezoelectric Z-positioner 10 as long as it generates a plurality of optical path differences between the first and second optical paths. The phase shifting mechanism 602 may be formed by an actuator for changing the position of the reference surface 606 in the optical axis direction, an actuator(s) for inserting and removing a plurality of phase plates having different thicknesses in at least one of the first and second optical paths, and the like.

The photo-detection unit 604 detects interference light caused by the reflected light and the reference light. The photo-detection unit 604 detects interference light at a plurality of optical path differences between the first and second optical paths. That is, when the optical path difference between the first and second optical paths is changed by the phase shifting mechanism 602, the photo-detection unit 604 detects at least interference light that is caused when the optical path difference is a first optical path difference and interference light that is caused when the optical path difference is a second optical path difference. Note that the phase of the light at the first optical path difference is different from that of the light at the second optical path difference. The photo-detection unit 604 may be formed, for example, as the photodetector 19.

The standard tilt acquisition unit 603 includes a height information acquisition unit 607 and a tilt information acquisition unit 608. The standard tilt acquisition unit 603 may be formed as the computer 6 described above. As will be described later, the height information acquisition unit 607 acquires height information at a plurality of measurement points on the sample 101 based on the result of the detection of interference light at a plurality of optical path differences (optical path differences between the first and second optical paths). As will be described later, the tilt information acquisition unit 608 acquires tilt information based on the height information at the plurality of measurement points. As will be described later, the standard tilt acquisition unit 603 acquires a standard tilt φ based on statistical processing performed for the plurality of pieces of tilt information. The configuration of each of the height information acquisition unit 607, the tilt information acquisition unit 608, and the standard tilt acquisition unit 603 will be described hereinafter in this order.

### (Part 1. Height Information)

The height information acquisition unit 607 acquires height information at measurement points on the sample 101, for example, as described below. Note that the below-described procedure is based on a known phase shift interferometry. A change in the contrast value of one pixel when the focal position of an image in which interference fringes appear is shifted in the optical axis direction is expressed by the below-shown mathematical expression.

$$\begin{matrix}[ Expression 1 ] & \\ F = {I}_{0} + {I}_{1} cos θ & ( 1 )\end{matrix}$$

In the expression, θ is a phase difference between the reference light and the reflected light. Further, I₀ is a bias, and I₁ is an amplitude of an interference signal when the optical path difference between the first and second optical paths is shifted to a plurality of optical path differences (in this embodiment, the phase of the reflected light is shifted to a plurality of phases by the driving of the piezoelectric Z-positioner 10). In this embodiment, the change in the optical path difference by the phase shifting mechanism 602 is associated with the change in the phase of the reflected light. Then, the phase of the reflected light is shifted by π/2, π, and 3π/2, and contrast values B, C, and D, respectively, are thereby obtained.

The contrast values including a contrast value A before the shift can be expressed by the below-shown expressions, respectively.

$$\begin{matrix}[ Expression 2 ] & \\ A = {I}_{0} + {I}_{1} cos ( 0 - θ ) = {I}_{0} + {I}_{1} cos θ & ( 2 )\end{matrix}$$

$$\begin{matrix}[ Expression 3 ] & \\ B = {I}_{0} + {I}_{1} cos ( π / 2 - θ ) = {I}_{0} + {I}_{1} sin θ & ( 3 )\end{matrix}$$

$$\begin{matrix}[ Expression 4 ] & \\ C = {I}_{0} + {I}_{1} cos ( π - θ ) = {I}_{0} - {I}_{1} cos θ & ( 4 )\end{matrix}$$

$$\begin{matrix}[ Expression 5 ] & \\ D = {I}_{0} + {I}_{1} cos ( 3 π / 2 - θ ) = {I}_{0} - {I}_{1} sin θ & ( 5 )\end{matrix}$$

From four data A, B, C, and D for each pixel, θ can be expressed by the below-shown expression.

$$\begin{matrix}[ Expression 6 ] & \\ θ = {tan}^{- 1} \frac{B - D}{A - C} & ( 6 )\end{matrix}$$

If the phase difference θ is known, the height δ is obtained by the below-shown expression.

$$\begin{matrix}[ Expression 7 ] & \\ δ = \frac{θ * λ}{4 π} & ( 7 )\end{matrix}$$

By the procedure for acquiring the height δ described above, the height information acquisition unit 607 acquires height information at a plurality of measurement points on the sample 101 based on the result of the detection of the interference light at the plurality of optical path differences (optical path differences between the first and second optical paths). The plurality of optical path differences include optical path differences at which the phase of the reflected light changes by 0, π/2, π, and 3π/2, respectively.

### (Part 2. Tilt Information)

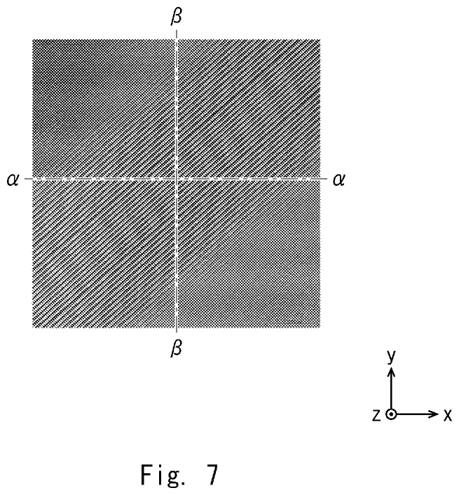

FIG. 7 shows an image obtained by expressing height information calculated from a luminance value of each pixel acquired by the height information acquisition unit 607 in gradation on a plane perpendicular to the primary optical axis of the interference-type objective lens 13 (i.e., the height image of the sample 101).

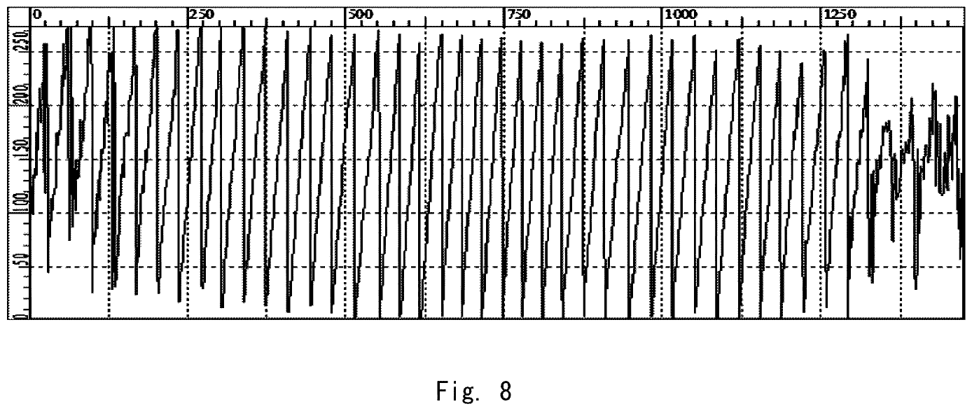

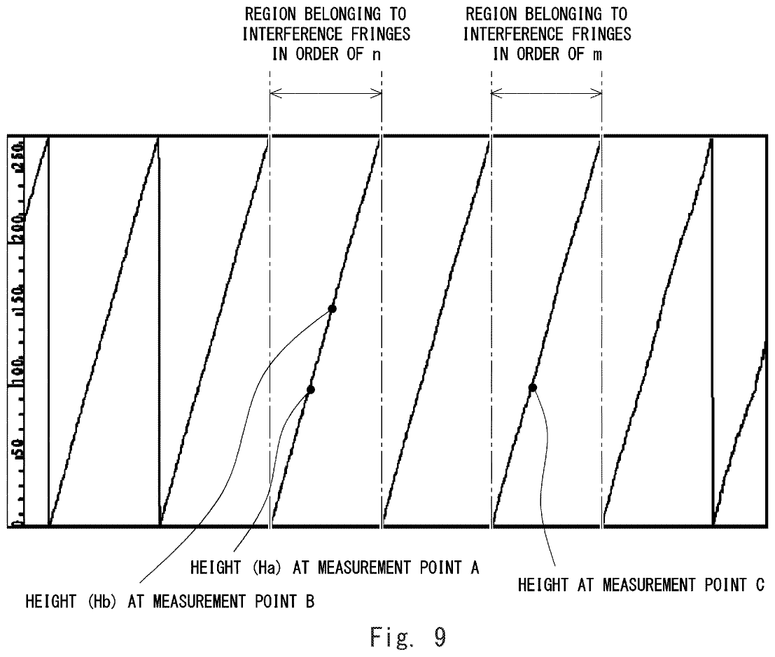

FIG. 8 shows height information on a line a-a shown in FIG. 7 (the line is parallel to the X axis for the sake of explanation). In FIG. 8, the horizontal axis indicates the coordinate position in the X-direction on a plane perpendicular to the primary optical axis, and the vertical axis indicates the height information (height) at respective X-coordinate positions obtained by the above-shown Expression (7). Further, FIG. 9 shows a part of the X-coordinate range (X=500 μm to 725 μm) shown in FIG. 8 shown on a different scale.

Note that the intensity (contrast) of the interference light when the phase difference between the reflected light that has passed through the reference surface and the reflected light that has passed through the sample 101 exceeds 2π cannot be distinguished from the intensity (contrast) when the phase difference is 0 to 2π. Therefore, since the height information returns to zero when the height exceeds a half of the wavelength (which is called phase wrapping), the height information changes along a saw-like waveform as shown in FIG. 9.

The tilt information acquisition unit 608 acquires tilt information between measurement points based on the height information at the plurality of measurement points. Specifically, the tilt information acquisition unit 608 may acquire a tilt between measurement points corresponding to pixels adjacent to each other. For example, referring to FIG. 9, the tilt information acquisition unit 608 acquires tilt information at a measurement point A on the sample 101 by calculating a difference between height information Hb at a measurement point B adjacent to the measurement A and height information Ha at the measurement point A, dividing the calculated difference by an interval (distance) between the measurement points B and A on the X axis coordinate (i.e., obtaining a value ΔZ/Δx), and then obtaining the arctangent of the value ΔZ/Δx (i.e., tilt information=arctan(ΔZ/Δx), the unit is degrees).

Note that Δx may be a distance between measurement points corresponding to pixels adjacent to each other. For example, the minimum distance that can be expressed by pixels is 1.44 μm (Δx=1.44 μm). Further, when the sample 101 is measured with light having a wavelength of 546 nm, the height information can be acquired up to Z=273 nm. Then, in this case, the tilt information is 10° (arctan(273 nm/1.44 μm) at the maximum.

### (Part 3. Standard Tilt)

The standard tilt acquisition unit 603 acquires the standard tilt φ of the sample 101 based on statistical processing performed for a plurality of pieces of tilt information. For example, the standard tilt acquisition unit 603 acquires the standard tilt by using statistical values such as the average value, the mode, and the standard deviation of a plurality of pieces of tilt information. For example, the standard tilt acquisition unit 603 may acquire the standard tilt based on tilt information at the mode.

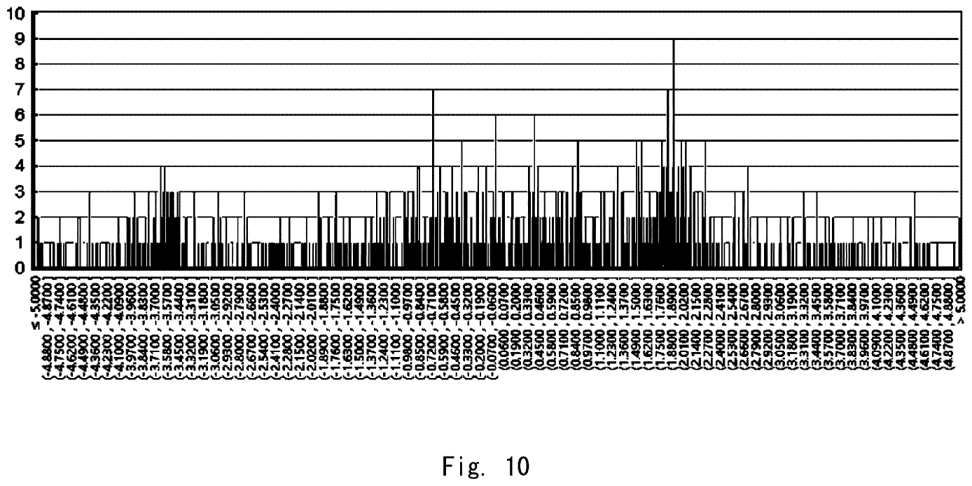

FIG. 10 is a histogram showing the frequences of appearances of a plurality of pieces of tilt information acquired by the tilt information acquisition unit 608 for each section of tilt information. According to this example shown in FIG. 10, the tilt information at the mode is 1.88° (to 1.89°) at which the frequency of appearances is nine times. Therefore, the standard tilt acquisition unit 603 may acquire 1.88° (to 1.89°) as the standard tilt φ of the sample.

It is considered that the measurement point C in FIG. 9 is phase-wrapped for the measurement points A and B. That is, the order of the interference fringes to which the measurement points A and B belong is different from the order of the interference fringes to which the measurement point C belongs. However, it is possible to calculate the tilt information at the measurement point C without being affected by the phase wrapping for the measurement points A and B. Therefore, the standard tilt acquisition unit 603 may include (i.e., incorporate) tilt information at measurement points belonging to interference fringes of orders different from each other in the statistical processing. That is, as shown in FIG. 9, the standard tilt acquisition unit 603 may include the tilt information at the measurement point A belonging to the interference fringes in the order n and the tilt information at the measurement point C belonging to the interference fringes in the order m (≠n) in the statistical processing.

With the above-described configuration, the standard tilt acquisition unit 603 can acquire the standard tilt φ of the sample 101.

It should be noted that there are cases where it is desired to perform a predetermined selection for removing noises or the like for the tilt information used in the statistical processing. Therefore, various “masking processes” for tilt information used in the statistical processing performed by the standard tilt acquisition unit 603 will be described hereafter.

### (First Masking Process)

For example, it can be seen that the amount of change in the signal strength resulting from the change in the optical path difference (change in phase) by the phase shifting mechanism, i.e., the amplitude (I₁) of the interference signal, is relatively small in the lower-right region and the upper-left region in FIG. 7. Further, it can be seen that, as a result, the amount of change in the signal strength resulting from the change in the optical path difference (change in phase) by the phase shifting mechanism, i.e., the amplitude (I₁) of the interference signal, is relatively small in the regions at both ends of the horizontal axis in FIG. 8. Therefore, in FIG. 8, the regions at both ends of the horizontal axis are more likely to contain noises than the region at the center of the horizontal axis.

Therefore, it may be preferred to perform a masking process for restricting the inclusion of tilt information at measurement points at which the amount of change in signal strength (amplitude I₁ of the interference signal) resulting from the change in optical path difference (phase change) by the phase shifting mechanism 602 is smaller than a predetermined value in the tilt information used for the statistical processing performed by the standard tilt acquisition unit 603. This masking process is referred to as a first masking process.

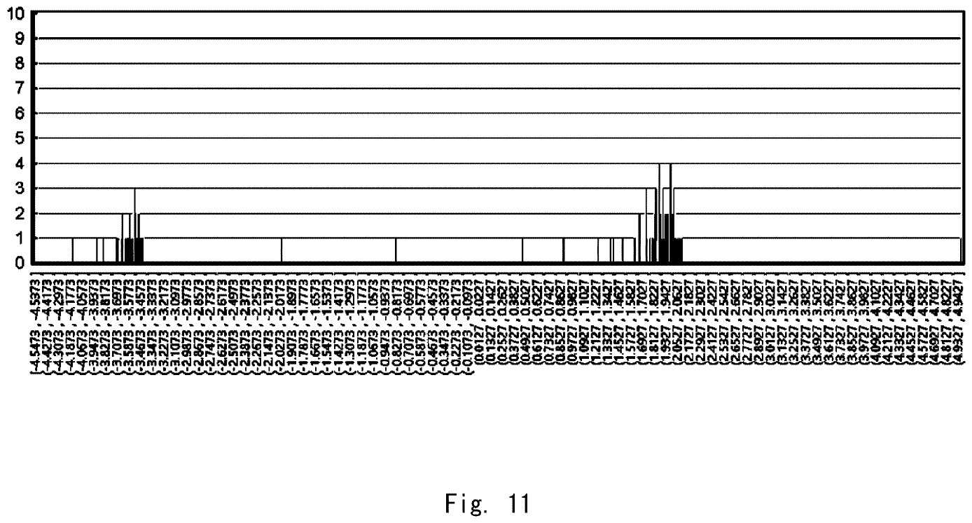

FIG. 11 is a schematically-shown histogram showing the frequences of appearances of a plurality of pieces of tilt information for each section of tilt information after a first masking process is performed. It can be said that compared with FIG. 10, the histogram shown in FIG. 11 is a histogram in which tilt information including the influence of noises is eliminated.

The first masking process can be performed by processing information so that the tilt information acquisition unit 608 restricts the acquisition of tilt information at measurement points at which the amount of change in signal strength (amplitude I₁ of the interference signal) resulting from the change in optical path difference (phase change) by the phase shifting mechanism is smaller than a predetermined value. However, the first masking process is not limited to this example. The first masking process can also be performed by processing information so that the standard tilt acquisition unit 603 restricts the inclusion of, among a plurality of pieces of tilt information, tilt information at measurement points at which the amount of change in signal strength (amplitude I₁ of the interference signal) resulting from the change in optical path difference (phase change) by the phase shifting mechanism is smaller than a predetermined value in the statistical processing, or can be performed by other configurations. All of these aspects can be included in the first masking process in which the standard tilt acquisition unit 603 restricts the inclusion of tilt information at measurement points at which the amount of change in signal strength (amplitude I₁ of the interference signal) resulting from the change in optical path difference (phase change) by the phase shifting mechanism is smaller than a predetermined value in the statistical processing.

### (Second Masking Processing)

In FIGS. 10 and 11, tilt information is also obtained at relatively high frequencies at and around −3.5°. However, this is because it is at the boundary of the phase wrapping, and it cannot be said that it represents the tilt information of the actual sample 101.

Therefore, it is desired to perform a masking process to restrict the inclusion of tilt information at measurement points at which the amount of change in the height information (absolute value of Δz) is larger than a predetermined value in the tilt information used for the statistical processing performed by the standard tilt acquisition unit 603. This masking process is referred to as a second masking process.

Tilt information at a measurement point at which the amount of change in the height information (absolute value of Δz) is larger than the predetermined value has a large absolute value. Therefore, the second masking process may include a process to restrict the use of tilt information of which the absolute value is larger than the predetermined value for the statistical processing performed by the standard tilt acquisition unit 603. Note that as will be described later, whether the tilt information has a positive sign or a negative sign, in addition to the magnitude of the absolute value of the tilt information, may be taken into consideration in the second masking process.

The second masking process can be performed by processing information so that the tilt information acquisition unit 608 restricts the acquisition of tilt information at or near the measurement point at which the height information at which the phase wrapping occurs is acquired. However, the second masking process is not limited to this example. The second masking process can also be performed by processing information so that the standard tilt acquisition unit 603 restricts the inclusion of tilt information larger than the predetermined value in the statistical processing, or can be performed by other configurations. All of these aspects can be included in the second masking process in which the standard tilt acquisition unit 603 restricts the inclusion of tilt information at a measurement point at which the amount of change in the height information is larger than the predetermined value in the statistical processing.

A threshold value for the second masking process (threshold value for the amount of change in the height information (absolute value of Δz) or a threshold value for the tilt information) may be set based on the value of the height information δ or the value of the tilt information at the measurement point at which phase wrapping occurs. The value of the height information δ at the measurement point at which phase wrapping occurs can be estimated based on Expression (7). The value of the tilt information at the measurement point at which phase wrapping occurs can be estimated based on Expression (7) and the distance between measurement points adjacent to each other. Note that it is conceivable that the tilt information obtained by the phase wrapping may have a sign opposite to that of the tilt information considered to be the standard tilt φ. Therefore, the second masking process may be a process for restricting the inclusion of tilt information having a predetermined sign in the statistical processing in an unrestricted manner. Alternatively, this masking process may be regarded as another type of masking process (third masking process) different from the above-described masking processes. That is, the standard tilt acquisition unit 603 may perform the third masking process for restricting the inclusion of tilt information having a predetermined sign in the statistical processing.

The standard tilt acquisition unit 603 may perform any of various types of masking processes described above, and by doing so, can acquire the standard tilt φ in a more suitable manner.

### Modified Example 1

In some embodiments, the measuring apparatus 100 may include a sample characteristic information acquisition unit 609. The sample characteristic information acquisition unit 609 acquires characteristic information of the sample 101 by an arbitrary method, such as designation by a user, identification by identification information provided in (i.e., assigned to) the sample 101, or a result of photographing of the sample 101 by a microscope unit. For example, the sample characteristic information acquisition unit 609 may be formed as a computer 6 that performs processing based on the result of the detection by the photo-detection unit 604.

The characteristic information of the sample 101 acquired by the sample characteristic information acquisition unit 609 may include information related to the shape and the formation of the sample 101, such as whether or not the sample 101 is formed of a flat surface, whether or not it is formed of a curved surface, and whether or not a pattern is formed therein. Further, the standard tilt acquisition unit 603 acquires the standard tilt φ of the sample 101 based on statistical processing determined based on the characteristic information of the sample 101.

As will be described below, how the standard tilt φ appears may change depending on the shape and the formation of the sample 101. Therefore, in some embodiments, the measuring apparatus 100 may selectively use the contents of the statistical processing performed in the standard tilt acquisition unit 603 according to the sample characteristic.

### (Part 1. Sample Having Pattern-Less Flat Surface)

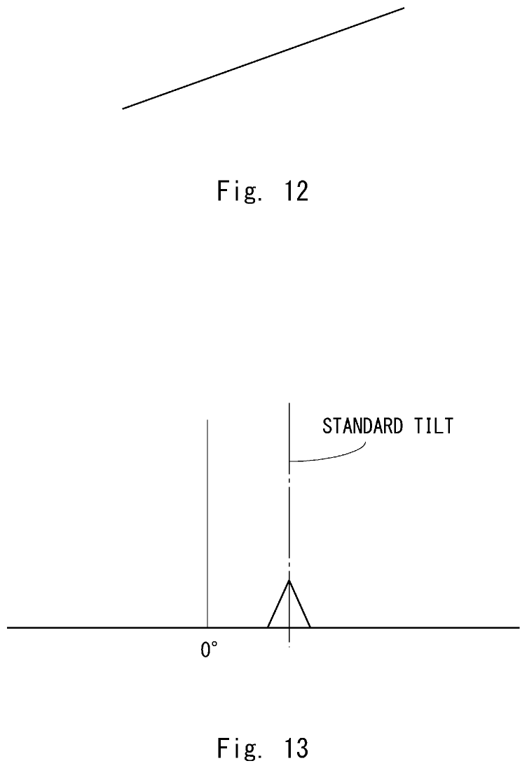

FIG. 12 is a schematic diagram of a cross section of a sample 101 formed of a pattern-less flat surface. In this case, as shown in FIG. 13, a peak of the frequency of appearances appears at a position away from 0 degrees in the histogram for tilt information at a plurality of measurement points acquired by the tilt information acquisition unit 608. Note that it can be said that since the sample 101 is a sample formed of a pattern-less flat surface, the standard tilt φ of the sample 101 roughly coincides with the tilt information at this peak position.

Therefore, when the sample 101 is a sample formed of a pattern-less flat surface, the standard tilt acquisition unit 603 specifies a distribution having the highest peak from a distribution chart (histogram) showing the frequency of appearances of tilt information in a plurality of sections of tilt information, calculates a representative tilt in the distribution having the highest peak, and acquires the representative tilt as the standard tilt of the sample 101. Note that the representative tilt of the distribution may be tilt information at the peak of the distribution, or may be an average value or a median of tilt information at and around the peak in the distribution.

### (Part 2. Sample Having Patterned Flat Surface)

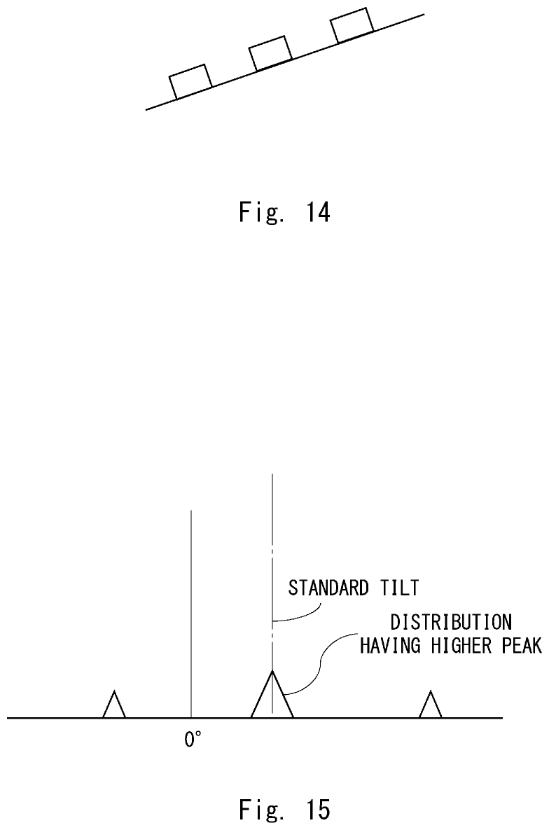

FIG. 14 is a schematic diagram of a cross section of a sample 101 formed of a patterned flat surface. In this case, as shown in FIG. 15, a plurality of distributions having different peak values of the frequencies of appearances appear in the histogram for tilt information at a plurality of measurement points acquired by the tilt information acquisition unit 608. Note that it can be said that since the sample 101 is a sample formed of a patterned flat surface, the standard tilt φ of the sample 101 roughly coincides with the tilt information at the peak position of the distribution having the highest peak among the plurality of peaks.

Therefore, when the sample 101 is a sample formed of a patterned flat surface, the standard tilt acquisition unit 603 specifies a distribution having the highest peak from a distribution chart (histogram) showing the frequency of appearances of tilt information in a plurality of sections of tilt information, calculates a representative tilt in the distribution having the highest peak, and acquires the representative tilt as the standard tilt of the sample.

### (Part 3. Sample Having Curved Surface)

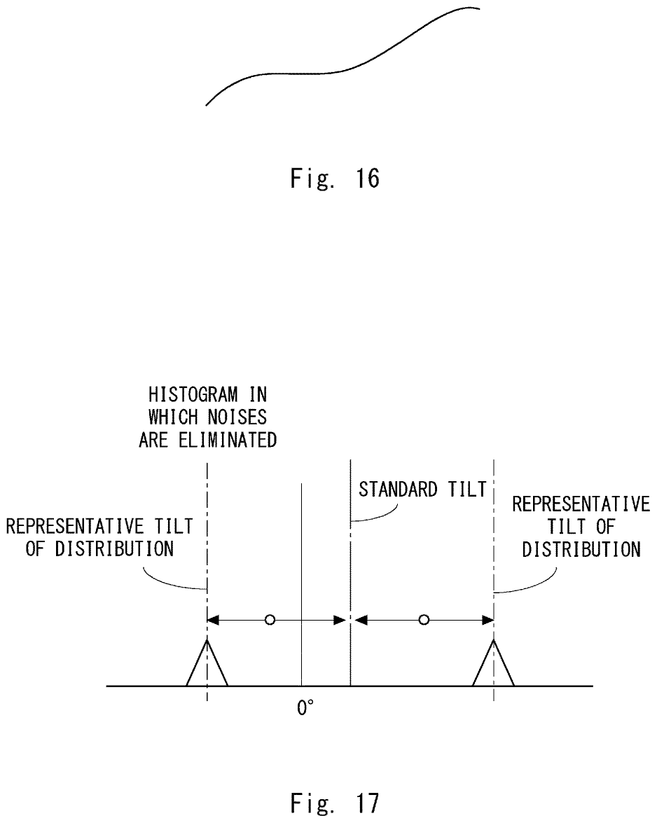

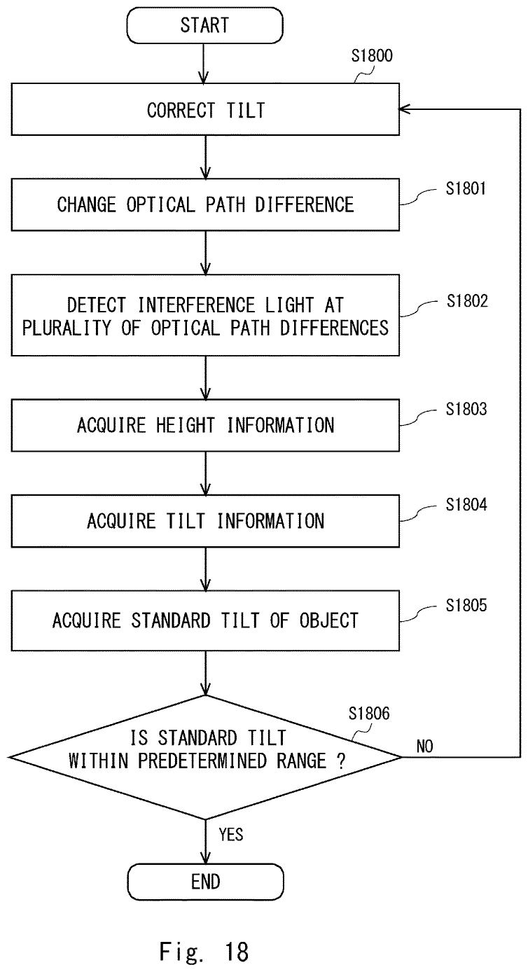

FIG. 16 is a schematic diagram of a cross section of a sample 101 formed of a curved surface. In this case, as shown in FIG. 17, two distributions having shapes similar to each other on the positive side and the negative side, respectively, of the angle of 0° in the histogram for tilt information at a plurality of measurement points acquired by the tilt information acquisition unit 608. Note that it can be said that since the sample 101 is a sample formed of a curved surface, the standard tilt φ of the sample 101 roughly coincides with the center of the two distributions.

Therefore, when the sample 101 is a sample formed of a curved surface, the standard tilt acquisition unit 603 specifies two distributions having shapes similar to each other on the positive side and the negative side, respectively, of the angle of 0° from a distribution chart (histogram) showing the frequency of appearances of tilt information in a plurality of sections of tilt information, calculates a representative tilt of each of the two distributions, and acquires an intermediate angle between the two representative tilts as the standard tilt of the sample.

### Modified Example 2

In some embodiments, the measuring apparatus 100 may include a determination unit 611. The determination unit 611 determines whether or not the standard tilt φ is within a predetermined range. Further, in some embodiments, the measuring apparatus 100 may include a tilt correction unit 610. The tilt correction unit 610 corrects the tilt of the sample 101 so as to cancel out the standard tilt (thereof obtained by the standard tilt acquisition unit 603 based on this standard tilt φ. Note that the tilt correction unit 610 may correct the tilt by generating and transmitting a drive signal to the gonio-stage 9.

Further, in some embodiments, the measuring apparatus 100 may repeat acquiring the standard tilt φ by the standard tilt acquisition unit 603 and correcting the tilt of the sample 101 so as to cancel out this standard tilt φ by the tilt correction unit until the standard tilt φ falls in a predetermined range. Note that in some embodiments, the correction of the tilt may be left to a user who manually adjusts the stage. In this case, the measuring apparatus 100 may be configured so as to output the standard tilt φ through a display unit or the like (not shown) so that the user can recognize the angle of the standard tilt φ.

The determination unit 611 and the tilt correction unit 610 described above may be formed, for example, as a computer 6.

Further, in some embodiments, the measuring apparatus 100 may acquire a surface profile of the sample 101 after it is positively determined that the standard tilt φ is within a predetermined range. The surface profile of the sample 101 includes information about the result of microscopic observation of, for example, the surface irregularity shape of the sample 101. The microscopic observation may be performed in at least one of the interferometer mode and the confocal mode. As described above, the interference-type objective lens 13 is selected in the interferometer mode, and the ordinary objective lens 16 is selected in the confocal mode. As is known, the surface profile of the sample 101, which is, for example, information about the fine surface irregularity shape of the sample 101, can be acquired through a phase shift method or the acquisition of a confocal image. Since the measuring apparatus 100 according to some embodiments acquires the surface profile of the sample 101 after it is positively determined that the standard tilt φ is within a predetermined range by the determination unit 611, it can be ensured that the microscopic observation is performed in a more suitable manner.

### Description of Method for Controlling Measuring Apparatus According to Embodiment

FIG. 18 is a flowchart of a method for controlling a measuring apparatus according to an embodiment. A method for controlling a measuring apparatus according to an embodiment will be described with reference to FIG. 18. Steps are also referred to as processes.

As shown in FIG. 18, first, the optical path difference between the first and second optical paths is changed (Step S1801). In this step, by controlling the phase shifting mechanism 602, a plurality of optical path differences are generated between the first and second optical paths, and the optical path differences are changed. Note that as an optional additional step according to the embodiment, the tilt may be corrected through the tilt correction unit 610 so as to cancel out the standard tilt (that has already acquired at a stage prior to the step S1801 (Step S1800).

Next, interference light at a plurality of optical path differences is detected (Step S1802). In this step, the photo-detection unit 604 is made (i.e., instructed) to detect interference signals caused by the reflected light and the reference light at the plurality of optical path differences. The interference light detected by the photo-detection unit 604 includes interference light that is caused when the optical path difference between the first and second optical paths is the first optical path difference, and interference light that is caused when the optical path difference is the second optical path difference. Further, the first and second optical path differences may include optical path differences at which the phase of the reflected light changes by π/2, π, and 3π/2.

Next, the standard tilt φ of the sample 101 is acquired in steps S1803 to S1805. Firstly, height information is acquired (Step S1803). In this step, the height information acquisition unit 607 acquires height information at a plurality of measurement points on the sample 101 based on the result of the detection of interference signals that are obtained when the sample 101 is illuminated at the plurality of optical path differences.

Next, tilt information is acquired (Step S1804). In this step, the tilt information acquisition unit 608 acquires tilt information between measurement points based on the height information at the plurality of measurement points.

Lastly, the standard tilt φ of the sample 101 is acquired (Step S1805). In this step, the standard tilt acquisition unit 603 acquires the standard tilt of the sample 101 based on statistical processing performed for a plurality of pieces of tilt information. Note that as an optional additional step according to the embodiment, it may be determined whether or not the standard tilt φ remains in the predetermined range at a stage subsequent to the step S2305 (Step S1806). Further, as an optional additional step according to the embodiment, the series of processes may be finished when the determination result in the step S1806 is YES. On the other hand, when the determination result in the step S1806 is NO, the process returns to the step S1800 and the above-described series of steps may be repeated.

Note that the present disclosure is not limited to the above-described embodiments, and they may be modified as appropriate without departing from the scope and spirit of the disclosure. Further, in the description above, for the sake of simplicity, the acquisition and the like of the height information along the X axis (e.g., the cross section taken along the line α-α shown in FIG. 7), the tilt information, and the standard tilt φ have been described. However, since the standard tilt of the sample 101 is three dimensional, in some embodiments, the measuring apparatus 100 may be configured so as to acquire height information along the Y-axis (e.g., the cross section taken along the line β-β shown in FIG. 7), the tilt information, and the standard tilt φ in parallel with the above-described processing along the X axis. That is, an example in which the above-described description is applied to a direction along the Y-axis is also within the scope of the technical concept of the present disclosure. Further, an example in which the above-described description is applied to each of a direction along the X axis and a direction along the Y-axis is also within the scope of the technical concept of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A measuring apparatus comprising:
an optical system comprising a photo-detection unit, a separation part configured to separate illumination light emitted from a light source, and a reference surface, and configured to guide interference light caused by reflected light of sample illumination light reflected on a sample and reference light of reference illumination light reflected on the reference surface to the photo-detection unit, the sample illumination light being light originally traveling through the separation part toward the sample, and the reference illumination light being light originally traveling through the separation part toward the reference surface;
a phase shifting mechanism configured to generate a plurality of optical path differences between a first optical path and a second optical path, the first optical path including at least one of an optical path of the sample illumination light and an optical path of the reflected light, and the second optical path including at least one of an optical path of the reference illumination light and an optical path of the reference light; and
a standard tilt acquisition unit configured to acquire a standard tilt of the sample,
wherein the photo-detection unit is configured to detect the interference light at the plurality of optical path differences, and
wherein the standard tilt acquisition unit is configured to:
acquire height information at a plurality of measurement points on the sample based on a result of the detection of the interference light at the plurality of optical path differences;
acquire tilt information between measurement points based on the height information at the plurality of measurement points; and
acquire the standard tilt based on statistical processing performed for a plurality of pieces of tilt information.

2. The measuring apparatus according to claim 1, wherein the standard tilt acquisition unit acquires the standard tilt based on, among the plurality of pieces of tilt information, a tilt of which a frequency of appearance is larger than a predetermined value.

3. The measuring apparatus according to claim 1, wherein the standard tilt acquisition unit includes tilt information at measurement points belonging to interference fringes of orders different from each other in the statistical processing.

4. The measuring apparatus according to claim 1, wherein the standard tilt acquisition unit performs a first masking process for restricting inclusion of tilt information at a measurement point at which an amplitude of an interference signal is smaller than a predetermined value in the statistical processing, the amplitude of the interference signal being based on a change of the optical path difference by the phase shifting mechanism.

5. The measuring apparatus according to claim 1, wherein the standard tilt acquisition unit performs a second masking process for restricting inclusion of tilt information at a measurement point at which an amount of change in height information is larger than a predetermined value in the statistical processing.

6. The measuring apparatus according to claim 1, further comprising:
a determination unit configured to determine whether or not the standard tilt is within a predetermined range; and
a tilt correction unit configured to correct a tilt of the sample based on the standard tilt,
wherein the measuring apparatus repeats acquiring the standard tilt and correcting the tilt of the sample based on the standard tilt until the standard tilt falls in the predetermined range.

7. The measuring apparatus according to claim 1, further comprising a determination unit configured to determine whether or not the standard tilt is within a predetermined range,
wherein the measuring apparatus acquires, after positively determining that the standard tilt is within the predetermined range, a surface profile of the sample.

8. The measuring apparatus according to claim 1, further comprising a sample characteristic information acquisition unit configured to acquire characteristic information of the sample,
wherein the standard tilt acquisition unit acquires the standard tilt of the sample based on statistical processing determined based on the characteristic information of the sample.

9. A method for controlling a measuring apparatus, the measuring apparatus comprising:
an optical system comprising a photo-detection unit, a separation part configured to separate illumination light emitted from a light source, and a reference surface, and configured to guide interference light caused by reflected light of sample illumination light reflected on a sample and reference light of reference illumination light reflected on the reference surface to the photo-detection unit, the sample illumination light being light originally traveling through the separation part toward the sample, and the reference illumination light being light originally traveling through the separation part toward the reference surface; and
a phase shifting mechanism configured to generate a plurality of optical path differences between a first optical path and a second optical path, the first optical path including at least one of an optical path of the sample illumination light and an optical path of the reflected light, and the second optical path including at least one of an optical path of the reference illumination light and an optical path of the reference light;
the method comprising:
generating, by controlling the phase shifting mechanism, the plurality of optical path differences between the first and second optical paths;
making the photo-detection unit detect the interference light at the plurality of optical path differences; and
acquiring a standard tilt of the sample based on a result of the detection by the photo-detection unit,
wherein the acquiring of the standard tilt of the sample includes:
acquiring height information at a plurality of measurement points on the sample based on a result of the detection of the interference light at the plurality of optical path differences;
acquiring tilt information between measurement points based on the height information at the plurality of measurement points; and
acquiring the standard tilt based on statistical processing performed for a plurality of pieces of tilt information.

10. The control method according to claim 9, wherein in the acquiring of the standard tilt, the standard tilt is acquired based on, among the plurality of pieces of tilt information, a tilt of which a frequency of appearance is larger than a predetermined value.

11. The control method according to claim 9, wherein in the acquiring of the standard tilt, tilt information at measurement points belonging to interference fringes of orders different from each other in the statistical processing is included in the statistical processing.

12. The control method according to claim 9, wherein in the acquiring of the standard tilt, a first masking process for restricting inclusion of tilt information at a measurement point at which an amplitude of an interference signal is smaller than a predetermined value in the statistical processing is performed, the amplitude of the interference signal being based on a change of the optical path difference by the phase shifting mechanism.

13. The control method according to claim 9, wherein in the acquiring of the standard tilt, a second masking process for restricting inclusion of tilt information at a measurement point at which an amount of change in the height information is larger than a predetermined value in the statistical processing is performed.

14. The control method according to claim 9, further comprising:
determining whether or not the standard tilt is within a predetermined range; and
correcting a tilt of the sample based on the standard tilt,
wherein the acquiring of the standard tilt and the correcting of the tilt of the sample based on the standard tilt is repeated until the standard tilt falls in the predetermined range.

15. The control method according to claim 9, further comprising:
determining whether or not the standard tilt is within a predetermined range; and
acquiring, after positively determining that the standard tilt is within the predetermined range, a surface profile of the sample.

16. The control method according to claim 9, further comprising acquiring characteristic information of the sample,
wherein, in the acquiring of the standard tilt, the standard tilt of the sample is acquired based on statistical processing determined based on the characteristic information of the sample.
